(19) United States
(12) Patent Application Publication
(10) Pub. No.: US 2026/0126799 A1
(43) Pub. Date: May 7, 2026

(54) LANGUAGE-GROUNDED VEHICLE PATH PLANNING

(71) Applicant: QUALCOMM Incorporated, San Diego, CA (US)

(72) Inventors: Rajeev YASARLA, San Diego, CA (US); Deepti Balachandra HEGDE, San Diego, CA (US); Shizhong Steve HAN, San Diego, CA (US); Hong CAI, San Diego, CA (US); Shweta MAHAJAN, San Diego, CA (US); Apratim BHATTACHARYYA, San Diego, CA (US); Risheek GARREPALLI, San Diego, CA (US); Yunxiao SHI, San Diego, CA (US); Manish Kumar SINGH, San Diego, CA (US); Litian LIU, San Diego, CA (US); Fatih Murat PORIKLI, San Diego, CA (US)

(21) Appl. No.: 18/934,765

(22) Filed: Nov. 1, 2024

(51) Int. Cl. G05D 1/246; G05D 101/15; G06F 40/284; G06T 7/246; G06V 10/77; G06V 20/58; G06V 20/70

(52) U.S. Cl. CPC G05D 1/2467; G06T 7/246; G06V 10/7715; G06V 20/58; G06V 20/70; G05D 2101/15; G06F 40/284; G06T 2207/20081; G06T 2207/30241; G06T 2207/30252

(57) ABSTRACT

A device includes a memory configured to store images representing scenes associated with a vehicle. The device includes one or more processors configured to obtain a set of images representing a scene associated with the vehicle. The one or more processors are configured to generate, based on the set of images, language-grounded scene tokens. The one or more processors are configured to provide the language-grounded scene tokens to a planning transformer to generate a path plan prediction for the vehicle.

### I. FIELD

The present disclosure is generally related to vehicle path planning for vehicle automation, and in particular to language-grounded vehicle path planning.

### II. DESCRIPTION OF RELATED ART

Vehicle autonomy is sometimes described in terms of several tasks, including perception, prediction, planning, and control tasks. The perception task generally includes operations related to analyzing the environment around the vehicle, such as determining where the vehicle is relative to objects, other vehicles, or landmarks in the environment. The prediction task generally includes operations related to identifying expected or predicted future actions or relative positions of the objects, other vehicles or landmarks. The planning tasks generally include operations related to planning movements of the vehicle being controlled (commonly referred to as the “ego-vehicle”) in view of the results of the perception task, the prediction task, and goals associated with the vehicle. The control tasks generally include operations related to causing specific subsystems of the vehicle to implement some set of the planned movements.

Various approaches have been taken to use machine learning (ML) to perform some or all of these tasks. Nevertheless, there remain many challenges associated with ML-based vehicle autonomy. For example, perception and prediction tasks often rely on image data and/or sensor data to map an area around the vehicle and make predictions related to the vehicle's surroundings. Humans are generally more comfortable with specifying the vehicle's goals via natural-language instructions, and it can be challenging to integrate image data and natural-language instructions in order to make planning decisions that are based on both.

### III. SUMMARY

According to one implementation of the present disclosure, a device includes a memory configured to store images representing scenes associated with a vehicle. The device also includes one or more processors configured to obtain a set of images representing a scene associated with the vehicle. The one or more processors are configured to generate, based on the set of images, language-grounded scene tokens. The one or more processors are configured to provide the language-grounded scene tokens to a planning transformer to generate a path plan prediction for the vehicle.

According to another implementation of the present disclosure, a method includes obtaining a set of images representing a scene associated with a vehicle. The method includes generating, based on the set of images, language-grounded scene tokens. The method includes providing the language-grounded scene tokens to a planning transformer to generate a path plan prediction for the vehicle.

According to another implementation of the present disclosure, a non-transitory computer-readable medium stores instructions executable to cause one or more processors to obtain a set of images representing a scene associated with a vehicle. The instructions are executable to cause the one or more processors to generate, based on the set of images, language-grounded scene tokens. The instructions are executable to cause the one or more processors to provide the language-grounded scene tokens to a planning transformer to generate a path plan prediction for the vehicle.

According to another implementation of the present disclosure, an apparatus includes means for obtaining a set of images representing a scene associated with a vehicle. The apparatus includes means for generating, based on the set of images, language-grounded scene tokens. The apparatus includes means for providing the language-grounded scene tokens to a planning transformer to generate a path plan prediction for the vehicle.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a diagram illustrating aspects of a system for language-grounded vehicle path planning, in accordance with some examples of the present disclosure.

FIG. 2 is a diagram of illustrative aspects of operations associated with the system for language-grounded vehicle path planning of FIG. 1, in accordance with some examples of the present disclosure.

FIG. 3 is another diagram of illustrative aspects of operations associated with the system for language-grounded vehicle path planning of FIG. 1, in accordance with some examples of the present disclosure.

FIG. 4 is a diagram of illustrative aspects of operations associated with training the system for language-grounded vehicle path planning of FIG. 1, in accordance with some examples of the present disclosure.

FIG. 5 is a diagram of illustrative aspects of operations associated with a language-grounded scene model of the system for language-grounded vehicle path planning of FIG. 1, in accordance with some examples of the present disclosure.

FIG. 6 is a diagram of illustrative aspects of operations associated with the system for language-grounded vehicle path planning of FIG. 1, in accordance with some examples of the present disclosure.

FIG. 7 illustrates an example of an integrated circuit operable to perform language-grounded vehicle path planning, in accordance with some examples of the present disclosure.

FIG. 8 is a diagram of a mobile device operable to perform language-grounded vehicle path planning, in accordance with some examples of the present disclosure.

FIG. 9 is a diagram of a first example of a vehicle operable to perform language-grounded vehicle path planning, in accordance with some examples of the present disclosure.

FIG. 10 is a diagram of a second example of a vehicle operable to perform language-grounded vehicle path planning, in accordance with some examples of the present disclosure.

FIG. 11 is a diagram of a third example of a vehicle operable to perform language-grounded vehicle path planning, in accordance with some examples of the present disclosure.

FIG. 12 is a diagram of a particular implementation of a method of language-grounded vehicle path planning, in accordance with some examples of the present disclosure.

FIG. 13 is a block diagram of a particular illustrative example of a device that is operable to perform language-grounded vehicle path planning, in accordance with some examples of the present disclosure.

### V. DETAILED DESCRIPTION

Particular aspects of the disclosure relate to automation systems for vehicles. In particular, the disclosed automation systems facilitate improved scene analysis and planning by generating language-grounded scene data. In addition to improving planning relative to similar systems that do not use language-grounded scene data, the disclosed automation systems can also improve reliability of user interaction with the automation system using voice commands or text.

The disclosed automation systems process images (and optionally other sensor data) using one or more language-grounded machine-learning (ML) models to generate data descriptive of a scene around the vehicle. In this context, “language-grounded” indicates that the data descriptive of the scene is generated by one or more ML models that are trained based, at least in part, on language data. As one example, one or more scene ML models (e.g., an image encoder, a perception model, a prediction model, or a combination thereof) are configured to generate scene data representing a scene around a vehicle. In this example, the scene ML model(s) are trained as part of an end-to-end (E2E) automation pipeline that includes a planning model and a large language model (LLM). To illustrate, the scene data from the scene ML model(s) can be provided as input to the LLM to generate language output (e.g., language tokens). The language output represents descriptions of the scene, descriptions of predictions, answers to questions about the scene, etc. Training data used to train the E2E automation pipeline includes ground-truth labels (e.g., human labeled descriptions of the scene, etc.) which can be compared to the language output of the LLM to generate an error value. The error value is used to modify parameters (e.g., via backpropagation or another training process) of models of the E2E automation pipeline, including the scene ML model(s). Thus, the parameters of the scene ML model(s) are modified, based on language data, in a manner that improves overall operation of the E2E automation pipeline.

The LLM used during training of the E2E automation pipeline can be included in deployed instances of the E2E automation pipeline or omitted from the deployed instances of the E2E automation pipeline. For example, the LLM can optionally be omitted from the E2E automation pipeline when the E2E automation pipeline is deployed for use. To illustrate, after the scene ML model(s) are trained based on the language output of the LLM, the E2E automation pipeline can be deployed without the LLM, in which case the language-grounded scene data generated by the scene ML model(s) is provided to a planning model (e.g., a planning transformer) to generate vehicle path planning data (e.g., a waypoint trajectory prediction). In this example, the deployed instance of the E2E automation pipeline has a smaller memory footprint than the instance of the E2E automation pipeline that was trained (e.g., the E2E automation pipeline including the LLM) because LLMs have a large memory footprint. In addition to saving memory, deploying an instance of the E2E automation pipeline that does not include the LLM can conserve other computing resources. For example, since the LLM is omitted, computing resources such as power, processing time, cache, etc. associated with execution of the LLM are conserved, while nevertheless providing language-grounded results.

Optionally, the LLM can be deployed with the E2E automation pipeline and only selectively used during inference time. For example, the LLM can be used in circumstances where sufficient computing resources (as determined based on processor capabilities and availability, working memory capacity and availability, power capacity and availability, etc.) are available. To illustrate, the E2E automation pipeline can use the LLM when a computing device is plugged into an external power source and omit use of the LLM when the computing device is operating on internal battery power. In this illustrative example, the internal battery power is assumed to be much more limited than power available from the external power source; thus, the additional power consumption due to use of the LLM is less impactful to the overall user experience making use of the LLM worthwhile. In other examples, whether the LLM is used can be based on user configurable settings, based on a type of input received from the user, or based on other factors. Whether or not the LLM is deployed and used with the E2E automation pipeline, language grounding of the scene ML model(s) can improve operation of a vehicle automation system that includes the E2E automation pipeline relative to vehicle automation systems that use scene models that are not language grounded. For example, in one set of tests, an L2 error of a vehicle automation system that was not language grounded was improved from an average value of 0.78 to an average value of 0.52 by the addition of a language-grounded scene model even though the LLM used in training was omitted from the vehicle automation system during inference. In the same tests, additional improvements in the L2 error were achieved when the LLM used in training was also used during inference.

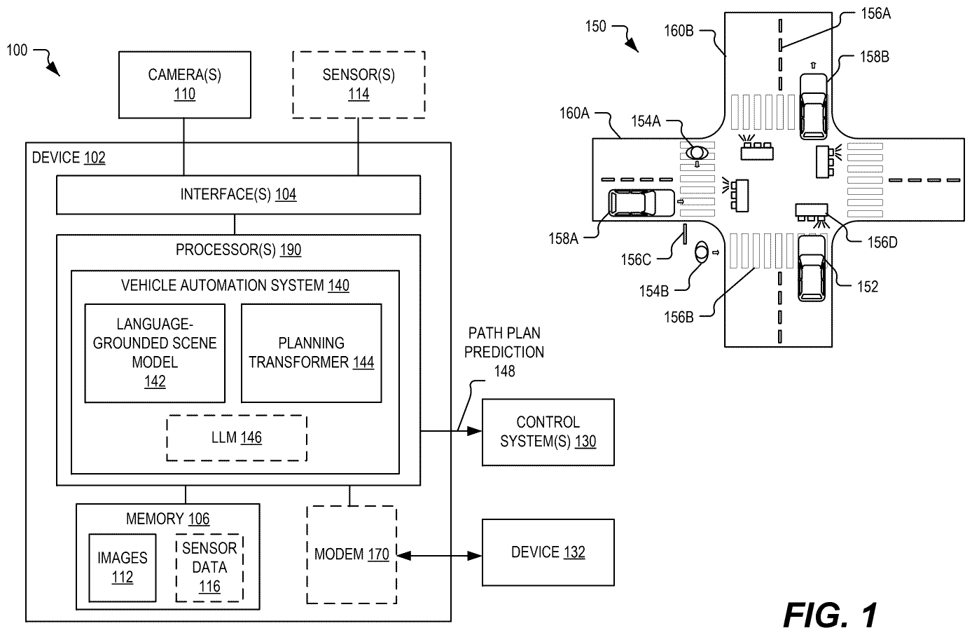

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple vehicles are illustrated and associated with reference numbers 158A and 158B. When referring to a particular one of these vehicles, such as a vehicle 158A, the distinguishing letter “A” is used. However, when referring to any arbitrary one of these vehicles or to these vehicles as a group, the reference number 158 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows - a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a diagram illustrating aspects of a system 100 for language-grounded vehicle path planning, in accordance with some examples of the present disclosure. FIG. 1 also includes a diagram 150 illustrating a simplified example of a scene associated with a vehicle. In the diagram 150, various vehicles 152, 158, objects, and other features of the scene are illustrated merely as one example of a scene associated with a vehicle and to facilitate understanding of various operations of the system 100.

The system 100 includes a device 102 that includes one or more processors 190 and a memory 106 coupled to the processor(s) 190. In FIG. 1, the device 102 also includes one or more interfaces 104 that are configured to couple to one or more input/output (IO) devices to enable exchange of data. For example, in FIG. 1, the IO device(s) include one or more cameras 110 and optionally one or more other sensors (e.g., sensor(s) 114). In this example, the camera(s) 110 are configured to capture images 112 of a scene associated with a vehicle. If the sensor(s) 114 are present, the sensor(s) 114 are configured to capture sensor data 116 associated with the scene. In some examples, the interface(s) 104 can also be coupled to output devices, such as a speaker or display, to provide a user with information based on results of operations performed by the device 102. Optionally, the device 102 can include a modem 170 to enable exchange of data with one or more other devices (e.g., a device 132) remote from the device 102.

The device 102 includes a vehicle automation system 140. For example, the vehicle automation system 140 can correspond to or include instructions that are executable by the processor(s) 190 to initiate, perform, or control various operations associated with automation of a vehicle (referred to herein as the “ego vehicle” when distinction from other vehicles is helpful). To illustrate, as described further below, the vehicle automation system 140 can configure the processor(s) 190 to perform operations associated with language-grounded vehicle path planning. In a particular aspect, language-grounded vehicle path planning operations can be performed to determine a path plan prediction 148 for a vehicle (e.g., the ego vehicle 152). The path plan prediction 148 can be provided to one or more control systems 130 of the ego vehicle to enable the control system(s) 130 to control various aspects of operation of the ego vehicle, such as primary control operations (e.g., steering, braking, acceleration, etc.), secondary control operations (e.g., turn signals, headlights, etc.), or both. Although the vehicles 152 and 158 are illustrated in the diagram 150 as cars, the vehicle automation system 140 can be used to perform path planning operations for other types of vehicles, such as other land vehicles (e.g., trucks), watercraft (e.g., ships or boats), or aircraft (e.g., fixed wing aircraft, rotary wing aircraft, aerostats, or hybrid aircraft).

In FIG. 1, the vehicle automation system 140 includes a language-grounded scene model 142 and a planning transformer 144. Optionally, the vehicle automation system 140 can also include a large language model (LLM) 146. The language-grounded scene model 142 and the planning transformer 144 include machine-learning models of an E2E automation pipeline for a vehicle. For example, the language-grounded scene model 142 can include one or more ML models that are trained to analyze a scene associated with the vehicle to identify locations of important objects or other features of the scene, to predict motion of vehicles or other objects in the scene, or both. In this example, the planning transformer 144 is configured to generate the path plan prediction 148 based on information from the language-grounded scene model 142.

In a particular aspect, the language-grounded scene model 142 is configured to perform analysis of the scene based on the images 112 and optionally other data, such as the sensor data 116. For example, the language-grounded scene model 142 is configured to generate scene feature data based on the images 112 and optionally based on the sensor data 116. The scene feature data can include or correspond to map data that represents objects in the scene. For example, the map data can include a set of values (e.g., a vector, an array, or a matrix) that encodes information about types of objects in the scene and locations (e.g., relative to the ego vehicle) of the objects in the scene. To illustrate, the map data can indicate (in encoded values) locations of street markings 156 relative to the ego vehicle 152. The map data can also distinguish (in the encoded values) the traffic control devices, such as lane markings 156A, crosswalk markings 156B, signage (e.g., a sign 156C), traffic signals 156D, other types of active or passive traffic controls, or combinations thereof. The map data can also indicate (in encoded values) types and/or locations of other objects in the scene, such as pedestrians 154, other vehicles 158, roadways 160, etc.

Additionally, or alternatively, the scene feature data can include or correspond to motion prediction data that represents trajectory predictions associated with the scene. For example, the motion prediction data can indicate (in encoded values) a direction and/or speed of movement (e.g., relative to the ego vehicle 152) of one or more of the pedestrians 154, one or more of the vehicles 158, or both. Motion predictions can be based, in part, on changes to the scene associated with the vehicle over time (e.g., based on a sequence of image frames) as well as training of the language-grounded scene model 142.

In some embodiments, the scene feature data includes several data elements (e.g., vectors or data structures) to represent the scene. For example, the scene feature data can include the map data, the motion prediction data, and optionally other data, such as image data representing the images 112, combined to form a set of input data for the planning transformer 144. In some such embodiments, the data elements generated by the language-grounded scene model 142 can be further processed to generate the input data for the planning transformer 144. For example, various data elements can be remapped (e.g., into a common feature space) or otherwise adapted to form scene tokens (e.g., language-grounded scene tokens) for input to the planning transformer 144.

The planning transformer 144 (or another self-attention model) is trained to perform vehicle path planning operations based on the scene feature data. For example, the planning transformer 144 is configured to generate the path plan prediction 148 based on the scene feature data. The path plan prediction 148 can indicate optimal or feasible paths for the ego vehicle 152 in view of identified aspects of the scene and goals of the ego vehicle 152. The goals of the ego vehicle 152 can include destinations, waypoints, operational limits (e.g., safety or legal constraints), etc. The path plan prediction 148 can include a waypoint prediction, a trajectory prediction, or a combination thereof (e.g., a waypoint trajectory prediction). Additionally, or alternatively, the path plan prediction 148 can indicate specific primary or secondary control objectives (e.g., a specific speed change, a specific direction change, etc.).

The path plan prediction 148 can be provided to control system(s) 130 of the ego vehicle 152 for implementation. The control system(s) 130 can include conventional controllers (e.g., proportional, integral, derivative (PID) controllers) configured to generate control signals for various subsystems of the ego vehicle 152 based on the path plan prediction 148. Controller(s) of the control system(s) 130 can optionally impose various operational limits, such as limits on the rate of change of various operational parameters, to improve safety and operation of the ego vehicle 152. Operations controlled based on the path plan prediction 148 can include primary control operations and/or secondary control operations. In some embodiments, the control systems 130 are integrated within the processor(s) 190. For example, the processor(s) 190 can execute instructions to generate vehicle control signals based on the path plan prediction 148.

In some embodiments, the device 102 is integrated within the ego vehicle 152; whereas in other embodiments, the device 102 is distinct from and possibly remote from the ego vehicle 152. For example, the device 102 can include or correspond to a mobile device used within the ego vehicle 152 or a server remote from the ego vehicle 152.

In embodiments in which the device 102 is integrated within the ego vehicle 152, the control systems 130 can receive the path plan prediction 148 directly from the processors 190 (e.g., via a bus). In embodiments in which the device 102 is not integrated within the ego vehicle 152, such as when the device 102 is temporarily in the ego vehicle 152 or when the device 102 is remote from the ego vehicle 152, the processors 190 can provide the path plan prediction 148 to the control systems 130 of the ego vehicle 152 through a communication path, such as a communication path supported by the modem 170. For example, the modem 170 can modulate the path plan prediction 148 according to a communication protocol such that the path plan prediction 148 can be transmitted over a wired or wireless communication signal to the ego vehicle 152.

In some embodiments in which the device 102 is not integrated within the ego vehicle 152, the camera(s) 110, the sensor(s) 114, or both, are integrated with or coupled to the device 102. For example, the device 102 can include a mobile device that includes the processors 190, the memory 106, the modem 170, and one or more of the cameras 110 (and optionally one or more of the sensor(s) 114). In this example, the device 102 can be mounted or otherwise positioned to capture images of a scene associated with the ego vehicle 152. To illustrate, the device 102 can be mounted on a dashboard when the ego vehicle 152 is a car or mounted on an external payload pylon when the ego vehicle 152 is an aircraft or watercraft. In such embodiments, the device 102 captures some or all of the data used to generate the path plan prediction 148 and send the path plan prediction 148 to the ego vehicle 152 to enable the control systems 130 of the ego vehicle 152 to control one or more aspects of operation of the ego vehicle 152. In some such embodiments, additional data representing the scene can be received at the device 102 from camera(s) 110 or sensor(s) 114 of the ego vehicle or other camera(s) 110 or sensor(s), such as an infrastructure camera along a roadway or cameras or sensors of another vehicle 158. For example, the device 132 can include or correspond to an external sensor or an external camera that provides data representing the scene to the device 102 using a vehicle-to-vehicle (V2V) communication protocol or a vehicle-to-everything (V2X) communication protocol.

In some embodiments in which the device 102 is not integrated within the ego vehicle 152, the camera(s) 110, the sensor(s) 114, or both, are remote from the device 102, in which case the images 112 (and optionally the sensor data 116) are received at the device 102 via the modem 170. For example, one or more of the cameras 110 (and optionally one or more of the sensor(s) 114) can be integrated within the ego vehicle 152 and configured to provide data representing the scene to the device 102 via the modem 170. To illustrate, the device 102 can include a mobile device that provides vehicle control information (e.g., the path plan prediction 148) to the ego vehicle 152 while the device 102 is communicatively coupled to the ego vehicle 152.

During operation, the device 102 obtains at least a set of the images 112 representing a scene associated with the ego vehicle 152 and generates language-grounded scene feature data (e.g., language-grounded scene tokens) based on the set of images 112. Optionally, the device 102 can also obtain at least a subset of the sensor data 116, in which case the language-grounded scene feature data can also be based on the sensor data 116. The device 102 can obtain the images 112 from the memory 106 or from cameras (e.g., the camera(s) 110), which may be coupled to or integrated with the ego vehicle 152, coupled to or integrated with the device 102, external to both the ego vehicle 152 and the device 102 (e.g., infrastructure cameras), or a combination thereof. Likewise, the sensor data 116 can be obtained from the memory 106 or from sensors (e.g., the sensor(s)114) coupled to or integrated with the ego vehicle 152, coupled to or integrated with the device 102, external to both the ego vehicle 152 and the device 102 (e.g., infrastructure sensors), or a combination thereof.

The device 102 can provide the language-grounded scene feature data (e.g., the language-grounded scene tokens) to the planning transformer 144 to generate the path plan prediction 148 for the ego vehicle 152. The path plan prediction 148 is provided to the control systems 130 of the ego vehicle 152, and the control systems 130 generate vehicle control signals based on the path plan prediction 148.

The system 100 enables vehicle automation in a manner that is based on language-grounded scene analysis without requiring inference time execution of an LLM. The language-grounded scene analysis enables improved planning relative to similar systems that do not use language-grounded scene analysis and does so in a manner that is resource efficient because the LLM 146 is not required to execute at inference time. Thus, a technical benefit of the system 100 is that it provides an efficient mechanism to improve path planning for vehicle automation.

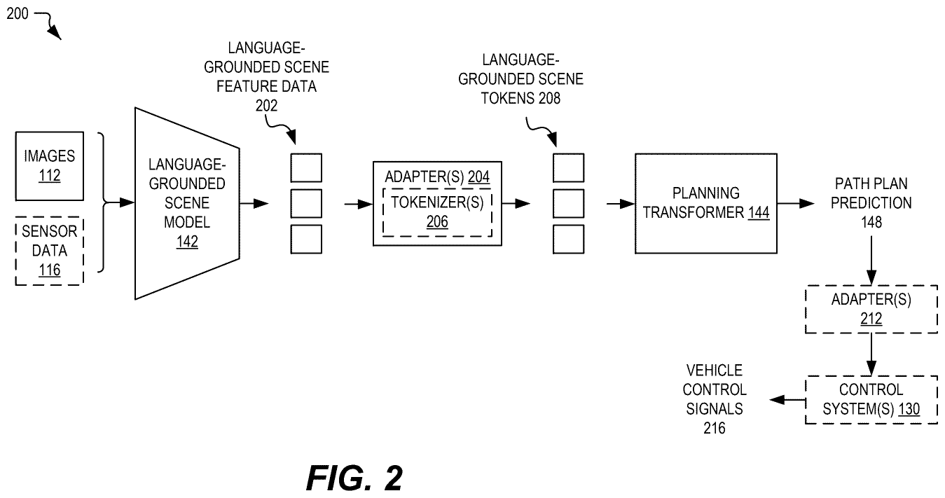

FIG. 2 is a diagram 200 of illustrative aspects of operations associated with the system 100 for language-grounded vehicle path planning of FIG. 1, in accordance with some examples of the present disclosure. In particular, the diagram 200 of FIG. 2 illustrates operations to generate the path plan prediction 148 based on images 112 and optionally sensor data 116.

In FIG. 2, the images 112 and optionally the sensor data 116 are provided as input data to the language-grounded scene model 142. In some implementations, the images 112, the sensor data 116, or both, can be pre-processed before being input to the language-grounded scene model 142. For example, the images 112, the sensor data 116, or both can be subjected to filtering, downsampling, upsampling, contrast modification, color modification, etc. As another example, two or more images 112, the sensor data 116, or both can be combined to form a bird's eye view representation of the scene associated with the ego vehicle 152. As yet another example, the pre-processing can include machine-vision processes (edge detection, blob detection, etc.) which are used to annotate the images 112, the sensor data 116, or both, or to generate additional input data for the language-grounded scene model 142.

The language-grounded scene model 142 includes one or more ML models that are configured to generate language-grounded scene feature data 202 based on the input data (e.g., the images 112, the sensor data 116, and/or annotations associated therewith). For example, the language-grounded scene model 142 can include a perception model that is configured to generate map data that indicates locations of objects or other features of the scene associated with the ego vehicle 152. Additionally, or alternatively, the language-grounded scene model 142 can include a prediction model that is configured to generate motion prediction data associated with the scene. Thus, the language-grounded scene feature data 202 can represent (in encoded values) map data, motion prediction data, tags associated with particular objects, other information about the scene, or combinations thereof.

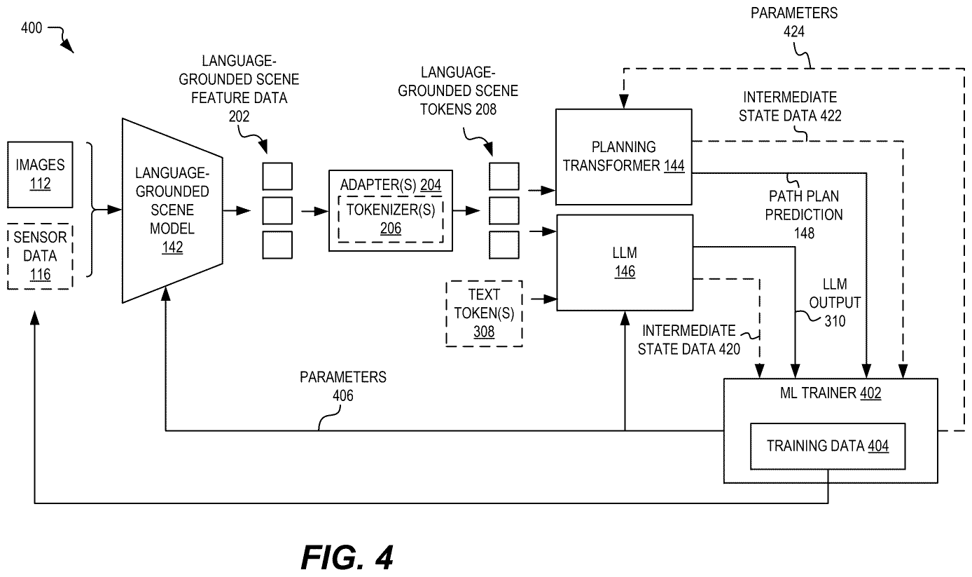

In a particular aspect, the ML model(s) of the language-grounded scene model 142 are trained (which may include retrained or fine-tuned) in conjunction with an LLM, as described further with reference to FIG. 4. Thus, the feature data output by the language-grounded scene model 142 is language-grounded in that the parameters of the ML model(s) of the language-grounded scene model 142 are adjusted based on language data.

In some embodiments, the language-grounded scene feature data 202 includes outputs (e.g., feature vectors) from multiple ML models of the language-grounded scene model 142. In such embodiments, the language-grounded scene feature data 202 can be processed by one or more adapters 204 to map the outputs into a common features space. The adapters 204 can include tokenizers 206 to generate language-grounded scene tokens 208 that are ready for input to the planning transformer 144.

The planning transformer 144 includes one or more ML models that are trained to generate the path plan prediction 148 based on the language-grounded scene feature data 202. For example, the language-grounded scene tokens 208 for a particular scene associated with the vehicle 152 can be provided as input to the planning transformer 144 to generate a path plan prediction 148 based on the particular scene. Over time, as the scene changes do to movement of the ego vehicle 152, movement of other vehicles or objects in the scene, or both, the path plan prediction 148 can be updated based on new image 112, and optionally new sensor data 116.

The path plan prediction 148 can be provided to the control systems 130, optionally after processing by one or more adapters 212. The control systems 130 are configured to generate vehicle control signals 216 to cause the ego vehicle 152 to operate based on the path plan prediction 148. For example, the vehicle control signals 216 can include signals that cause a brake controller of the ego vehicle 152 to apply brakes or release brakes. As another example, the vehicle control signals 216 can include signals that cause a speed controller of the ego vehicle 152 to increase or decrease the speed of the ego vehicle 152. As another example, the vehicle control signals 216 can include signals that cause a steering controller of the ego vehicle 152 to change a steering direction of the ego vehicle 152. In addition to primary control operations (such as braking, speed, and steering operations), the vehicle control signals 216 can include signals that cause one or more controllers of the ego vehicle 152 to perform secondary control operations, such as turning on or turning off head lights or turn signals.

In some embodiments, the planning transformer 144, the control systems 130, or both, apply operational limits (e.g., safety or legal constraints) to ensure that the ego vehicle 152 follows the path plan prediction 148 in a manner that is safe and legal. In some embodiments, the path plan prediction 148 indicates a waypoint, a trajectory, or a waypoint trajectory (e.g., a trajectory to a particular waypoint), and the control systems 130 generate the vehicle control signals 216 to navigate the ego vehicle 152 based on the path plan prediction 148. In some embodiments, the vehicle control signals 216 partially control the ego vehicle 152, and a vehicle operator controls other aspects of operation of the ego vehicle 152. For example, the vehicle operator can control the ego vehicle 152 to perform some driving situations, and the control systems 130 can control the ego vehicle 152 based on the path plan prediction 148 for certain other driving situations. To illustrate, the control systems 130 can control the ego vehicle 152 when the vehicle operator engages full or partial automatic control of the ego vehicle 152. In this context, “full automatic control” refers to autonomous operation of the vehicle (optionally based on goals specified by a user of the vehicle, such as user specified destination), and “partial automatic control” refers to automatic control of only some aspects of the ego vehicle 152, such as for lane following or adaptive cruise control. As another example, the control systems 130 can control the ego vehicle 152 during an emergency (e.g., a pedestrian steps in front of the ego vehicle 152) or if communication with a remote vehicle operator is lost.

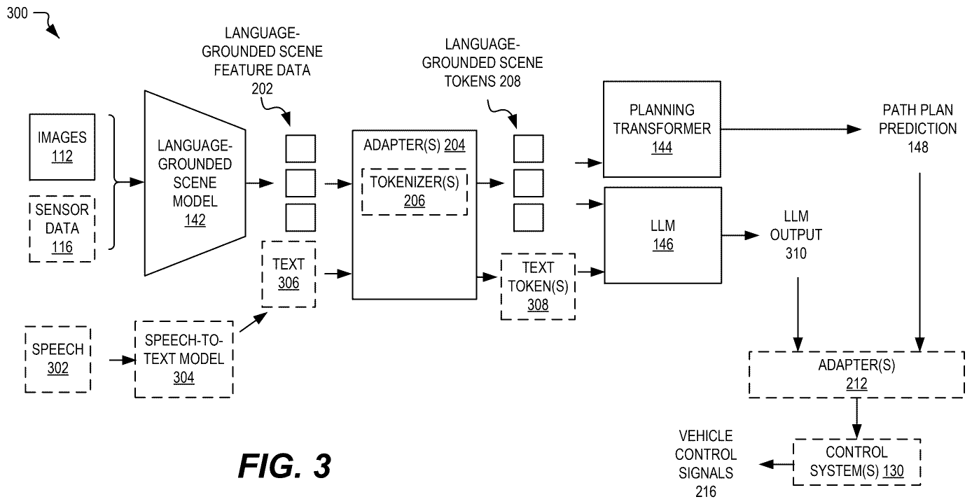

FIG. 3 is a diagram 300 of illustrative aspects of operations associated with the system 100 for language-grounded vehicle path planning of FIG. 1, in accordance with some examples of the present disclosure. In particular, the diagram 300 of FIG. 3 illustrates operations to generate the path plan prediction 148 based on images 112 and optionally based on sensor data 116, text 306, or both. The diagram 300 includes the LLM 146 as well as each of the features described with reference to FIG. 2, each of which operates as described with reference to FIGS. 1 and 2.

In FIG. 3, the language-grounded scene model 142 is configured to generate the language-grounded scene feature data 202 based on input data that includes the images 112, the sensor data 116, and/or annotations associated therewith. The language-grounded scene feature data 202 can be processed by the adapter(s) 204 (which may include the tokenizer(s) 206) to generate the language-grounded scene tokens 208. Optionally, in FIG. 3, the adapters 204 can also generate text token(s) 308 based on text 306. For example, the text 306 can be generated by a speech-to-text model 304 based on speech 302 provided by a party associated with the ego vehicle 152. For example, the speech 302 can include an instruction such as a destination or waypoint for the ego vehicle 152. As another example, the speech 302 can include a turn-by-turn instruction, such as “stop behind that yellow truck” or “turn after then next driveway”.

During one or more modes of operation, the language-grounded scene tokens 208 are provided to the planning transformer 144, which generates the path plan prediction 148 as described above. During one or more modes of operation, the language-grounded scene tokens 208 and optionally the text token(s) 308 are provided as input to the LLM 146, which generate the LLM output 310. The LLM output 310 can include a path plan prediction or other information related to the scene. In some embodiments, whether the planning transformer 144, the LLM 146, or both, are used to generate output is based on a configuration of the vehicle automation system 140. In such embodiments, the configuration of the vehicle automation system 140 can depend on a type of input provided by a user associated with the ego vehicle 152. For example, when the user provides the speech 302 as input to the vehicle automation system 140, the vehicle automation system 140 can use the LLM 146 (and optionally the planning transformer 144) to process information about the scene. As another example, the user or a system monitor (e.g., a processor monitor, a battery monitor, etc.) can select to use the LLM 146 when computing resources available for processing information about the scene satisfy specified selection criteria and can select to omit use of the LLM 146 when the computing resources available for processing information fail to satisfy the selection criteria.

In operational modes in which the language-grounded scene tokens 208 are provided as input to the LLM 146, in addition to or instead of, including representing the text 306, the text token(s) 308 can include data representing an LLM prompt. For example, if a user provided input in the form of the speech 302 or the text 306, the text token(s) 308 can represent the text 306 and the LLM prompt. However, if the user did not provide such input, the text token(s) 308 can include only the LLM prompt. In a particular example, the LLM prompt can prompt the LLM 146 to generate a path plan prediction as the LLM output 310.

The path plan prediction 148, the LLM output 310, or both, can be provided to the control systems 130, optionally after processing by one or more adapters 212. For example, when LLM output 310 includes a path plan prediction, the adapters 212 can selectively use the path plan prediction 148 from the planning transformer 144, the path plan prediction in the LLM output 310, or some combination thereof. To illustrate, a default one of the path plan prediction 148 or the path plan prediction in the LLM output 310 can be used based on an operating mode of the language-grounded scene model 142 or based on content of the path plan prediction 148 and/or the LLM output 310. The control systems 130 are configured to generate vehicle control signals 216 to cause the ego vehicle 152 to operate based on the path plan prediction 148, the LLM output 310, or both.

FIG. 4 is a diagram 400 of illustrative aspects of operations associated with training the system 100 for language-grounded vehicle path planning of FIG. 1, in accordance with some examples of the present disclosure. The diagram 400 includes various features described with reference to FIGS. 1-3, each of which operates during training as described above.

The diagram 400 also includes an ML trainer 402. The ML trainer 402 is configured to provide training data 404 representing a scene associated with a vehicle as input to the language-grounded scene model 142. The training data 404 can include images 112 associated with the scene, sensor data 116 associated with the scene, or both. The language-grounded scene model 142 processes the input data as described above to generate language-grounded scene feature data 202, which can be further processed by the adapters 204 to generate the language-grounded scene tokens 208. The language-grounded scene tokens 208 are provided as input to the planning transformer 144, the LLM 146, or both, during different phases of the training.

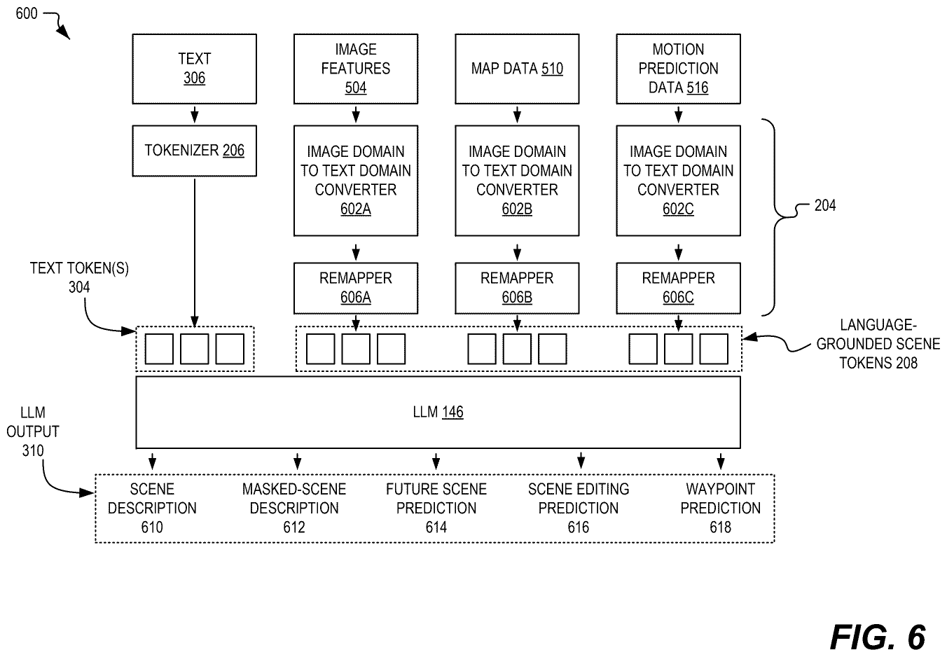

For example, during a training phase, to language ground the language-grounded scene model 142, the language-grounded scene tokens 208 and optionally the text token(s) 308 are provided as input to the LLM 146. In this training phase, the LLM 146 is configured to generate the LLM output 310 based on the language-grounded scene tokens 208 and optionally the text token(s) 308. The LLM output 310 includes text or text tokens descriptive of some aspect of the scene or descriptive of a path planning prediction, as described in more detail with reference to FIG. 6.

The LLM output 310 can be compared to corresponding ground-truth information in the training data 404 to generate one or more error values. The ML trainer 402 can use the error value(s) to determine updated parameters 406 for the language-grounded scene model 142 (e.g., using backpropagation techniques). For example, the error value(s) can be calculated using a visual question answering algorithm. In this example, the text token(s) 308 represent one or more questions about the scene (e.g., how many objects are present, where are specific object, which direction is a specific object moving, what would be the effect of changing an object's position in the scene, etc.), and the LLM output 310 includes answers to the question(s). In this example, the training data 404 includes ground-truth (e.g., human generated) answers to the question(s), and the error value(s) are based on differences between answers generated by the LLM 146 and the ground-truth answers.

During another training phase, a previously trained planning transformer can be updated to make use of the language-grounded scene tokens 208. The previously trained planning transformer corresponds to a planning transformer trained using conventional techniques, such as reinforcement learning operations and/or other image-based techniques, to perform path planning based on scene tokens. To illustrate, a scene model corresponding to the language-grounded scene model 142 before language grounding training) and a planning transformer (corresponding to the planning transformer 144 before language grounding of the scene model) can be trained as an end-to-end system for vehicle automation. During training of the planning transformer 144, the previously trained planning transformer can be updated to account for language grounding of the language-grounded scene model 142.

Another training phase can include using distillation to train (or further train) the planning transformer 144 based on data generated by the LLM 146. For example, optionally, intermediate state data 420 generated by the LLM 146 and intermediate state data 422 generated by the planning transformer 144 can be provided to the ML trainer 402. The intermediate state data 420 can include or correspond to output from a layer of the LLM 146 before a final output layer, such as a penultimate layer of the LLM 146 or an early layer. Likewise, the intermediate state data 422 can include or correspond to output from a layer of the planning transformer 144 before a final output layer, such as a penultimate layer of the planning transformer 144 or an early layer. The ML trainer 402 can determine a loss function (e.g., using Kullback-Leibler (KL) divergence) based on a comparison of a probability distribution of the intermediate state data 420 and a probability distribution of the intermediate state data 422, The ML trainer 402 can update parameters 424 of the planning transformer 144 based on the loss function. Such distillation training of the planning transformer 144 has the technical benefit (as shown in various experiments) of improving the path plan prediction 148 generated by the planning transformer 144.In some embodiments, the various training phases described above for training of the language-grounded scene model 142, the planning transformer 144, and the LLM 146 can proceed iteratively. For example, a scene model and a planning transformer can be trained (independently of language grounding) to generate path plan predictions based on images 112 and/or sensor data 116 from the training data 404.

After the scene model and the planning transformer are sufficiently trained (e.g., based on specified training endpoint criteria), the LLM 146 can be added and trained with the scene model to generate the language-grounded scene model 142 using the visual question answering techniques described above. After the language-grounded scene model 142 is sufficiently trained (e.g., based on specified training endpoint criteria), the planning transformer 144 can be trained using output (e.g., the language-grounded scene feature data 202 or the language-grounded scene tokens 208) of the language-grounded scene model 142 to refine the planning transformer 144 for use with the language-grounded scene model 142. After the planning transformer 144 is refined for use with the language-grounded scene model 142, distillation training can be performed to further refine the planning transformer 144 based on intermediate state data 420 from the LLM 146. Some or all of these various training operations can be repeated (in the same order or in a different order than described in the example above)until overall training endpoint criteria are satisfied. Further, the example above is merely illustrative. In other examples, the various training phases can be performed in a different order than described above.

Note that as a result of this training process, a scene model that is configured and trained to process image data (e.g., the images 112) and optionally sensor data 116 is modified in a manner that grounds the scene feature data generated by the scene model to language-based descriptions of the scene. For example, as a result of this training, the language-grounded scene tokens 208 provided as input to the LLM 146 result in more accurate descriptions of the scene in the LLM output 310. This language grounding improves the path plan predictions 148 made by the planning transformer 144 even after the LLM 146 is removed, as demonstrated by testing referenced above. Thus, operation of the language-grounded scene model 142 and the planning transformer 144 can be improved without using the additional resources the LLM 146 would consume. Further, when sufficient resources are available to use the LLM 146, the language-grounded scene model 142 can be used with the LLM 146 to improve operation of the system even more.

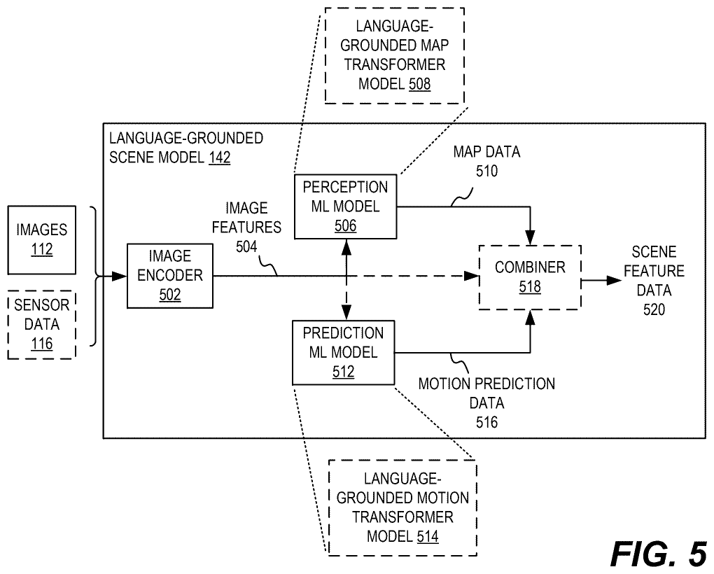

FIG. 5 is a diagram of illustrative aspects of operations associated with the language-grounded scene model 142 of the system for language-grounded vehicle path planning of FIG. 1, in accordance with some examples of the present disclosure. In the example illustrated in FIG. 5, the language-grounded scene model 142 of FIG. 5 includes multiple ML models which, together, generate various portions of scene feature data 520 as output of the language-grounded scene model 142. In other examples, the language-grounded scene model 142 includes more, fewer, or different ML models or other components.

The ML models of the language-grounded scene model 142 of FIG. 5 include an image encoder 502, a perception ML model 506, and a prediction ML model 512. The image encoder 502 is configured to generate image features 504 based on the images 112. Optionally, the image features 504 can also be based on the sensor data 116 and/or annotations added to the images 112 and/or the sensor data 116 during pre-processing.

The perception ML model 506 is configured to generate map data 510 based on the image features 504. The map data 510 indicates (in encoded values) locations of objects in the scene and identifications (e.g., object types) of such objects.

The prediction ML model 512 is configured to generate motion prediction data 516 based on the image features 504. In some embodiments, the prediction ML model 512 is configured to generate the motion prediction data 516 based on the image features 504 and the map data 510. The motion prediction data 516 indicates (in encoded values) motion predictions for objects in the scene.

The perception ML model 506, the prediction ML model 512, or both can be language grounded. For example, the perception ML model 506 can include or correspond to a language-grounded map transformer model 508, in which case the perception ML model 506 generates language-grounded map data. Additionally, or alternatively, the prediction ML model 512 can include or correspond to a language-grounded motion transformer model 514, in which case the prediction ML model 512 generates language-grounded motion prediction data.

In some embodiments, the scene feature data 520 generated by the language-grounded scene model 142 includes the map data 510, the motion prediction data 516, and optionally the image features 504. In some embodiments, the scene feature data 520 language-grounded scene model 142 includes a combiner 518 that generates the scene feature data 520 based on the map data 510, the motion prediction data 516, and optionally the image features 504. The combiner 518 is optional and is omitted in some embodiments.

FIG. 6 is a diagram 600 of illustrative aspects of operations associated with the system 100 for language-grounded vehicle path planning of FIG. 1, in accordance with some examples of the present disclosure. In particular, the diagram 600 illustrates aspects of operations related to processing scene data using the LLM 146.

In FIG. 6, the adapters 204 are configured to receive as input the text 306 and scene data generated by the language-grounded scene model 142. In the example illustrated, the scene data includes the image features 504, the map data 510, and the motion prediction data 516. In other examples, the scene data includes more, fewer, or different data elements. To illustrate, in some cases, the image features 504 can be omitted. As another illustrative example, in some cases, two or more of the image features 504, the map data 510, and the motion prediction data 516 can be combined (e.g., concatenated) to form a single data element.

In FIG. 6, the adapter(s) 204 include the tokenizer(s) 206. In this example, the tokenizer(s) 206 are configured to generate the text token(s) 308 based on the text 306. For example, the tokenizers 206 can be configured to parse the text into individual textual units, such as words or word parts (which themselves are often referred to as tokens), and map the textual units into a feature space for input to the LLM 146.

The adapters 204 can also include one or more image domain to text domain converters 602 that are configured to generate text domain data based on the scene data. For example, the image domain to text domain converters 602 can include one or more query transformers (“Q-former”, also sometimes referred to as querying transformers), which include transformer based models configured to generate text domain data based on image domain data (e.g., the image features 504, the map data 510, and/or the motion prediction data 516). Additionally, or alternatively, the image domain to text domain converters 602 can include one or more multimodal denoising image transformers 604 (MMDiT) configured to process image domain data and text domain data to generate text domain data that is denoised and better suited for question answering tasks used during training of the language-grounded scene model 142. In other examples, the image domain to text domain converters 602 can include other ML models (in addition to or instead of Q-formers and/or MMDiTs) to facilitate generation of text domain data from the scene data.

The adapters 204 can also include one or more remappers 606. The remapper(s) 606 are configured to map output of the image domain to text domain converters 602 into the same feature space as the text tokens 308 to generate the language-grounded scene tokens 208. The language-grounded scene tokens 208 and the text tokens 308 can be provided as input to the LLM 146 to generate the LLM output 310.

Content of the LLM output 310 can vary depending on a query of the text 306. For example, during training of the language-grounded scene model 142, the text 306 can include a query requesting a description of the scene, in which case the LLM output 310 can include a scene description 610. In this example, the scene description 610 can be compared to a ground-truth scene description (e.g., from the training data 404 of FIG. 4) to generate an error value used to adapt parameters of the language-grounded scene model 142. In some cases, the training data 404 can include masked image data in which one or more objects are masked out of the scene. In such cases, the text 306 can include a query requesting a description of the scene, in which case the LLM output 310 can include a masked-scene description 612. In this example, the masked-scene description 612 can be compared to a ground-truth scene description (e.g., from the training data of FIG. 4) to generate an error value used to adapt parameters of the language-grounded scene model 142.

As another example, the training data 404 can include a sequence of image data representing changes to the scene over time. In this example, the text 306 can include a query requesting a predictive description of a future scene, in which case the LLM output 310 can include a future scene prediction 614. In this example, the future scene prediction 614 can be compared to a ground-truth scene description (e.g., from the training data of FIG. 4) to generate an error value used to adapt parameters of the language-grounded scene model 142.

As another example, the text 306 can include a query requesting a predictive description of a result of editing the scene, in which case the LLM output 310 can include a scene editing prediction 616. In this example, the scene editing prediction 616 can be compared to a ground-truth scene description (e.g., from the training data of FIG. 4) to generate an error value used to adapt parameters of the language-grounded scene model 142.

As another example, during training of the language-grounded scene model 142 and/or during inference using the LLM 146, the text 306 can include a query requesting a waypoint prediction (or another type of path plan prediction), in which case the LLM output 310 can include a waypoint prediction 618. During training, the waypoint prediction 618 can be compared to a path plan prediction 148 generated by the planning transformer 144 based on the same scene data to generate an error value used to adapt parameters of the language-grounded scene model 142, the planning transformer 144, or both. During inference, the waypoint prediction 618 can be used as the path plan prediction 148 that is provided to the control systems 130 associated with the ego vehicle 152.

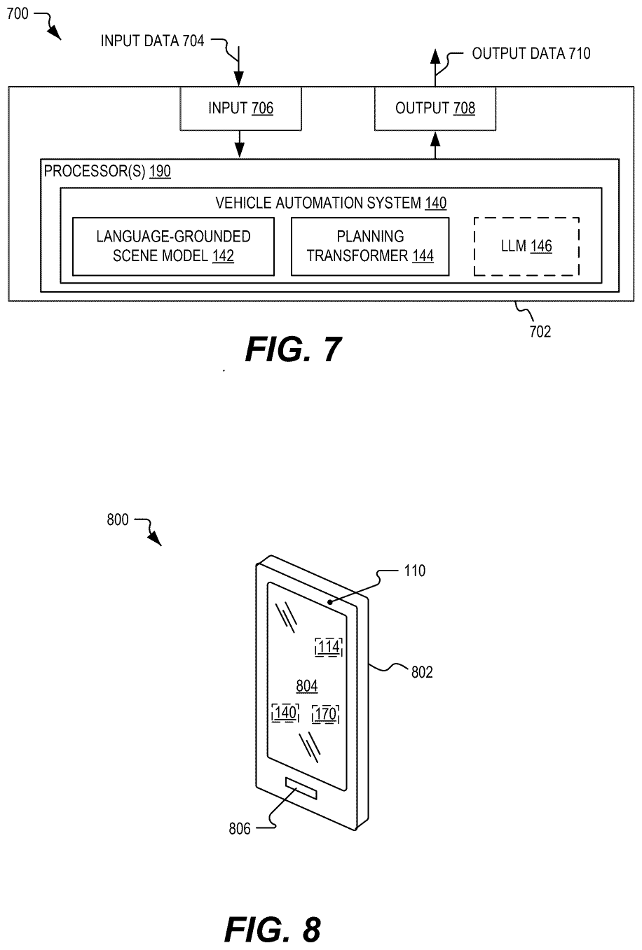

FIG. 7 depicts an implementation 700 of the device 102 as an integrated circuit 702 that includes the one or more processors 190. The integrated circuit 702 also includes an input 706, such as one or more bus interfaces, to enable input data 704 to be received for processing. For example, the input data 704 can include the images 112, the sensor data 116, the speech 302, the text 306, portions of the training data 404, or other information descriptive of the scene. The integrated circuit 702 also includes an output 708, such as a bus interface, to enable sending of output data 710 from the integrated circuit 702. For example, the output data 710 can include the path plan prediction 148, the LLM output 310, other output from the vehicle automation system 140, or a combination thereof.

The integrated circuit 702 enables implementation of the vehicle automation system 140 as a component in a device, such as a mobile computing device (e.g., a mobile phone, a tablet, or a special-purpose vehicle automation device) or a vehicle. For example, in FIG. 7, the integrated circuit 702 includes the language-grounded scene model 142 and the planning transformer 144. Optionally, the integrated circuit 702 can also include the LLM 146.

FIG. 8 depicts an implementation 800 in which the device 102 includes a mobile device 802, such as a phone, a tablet, or a special purpose vehicle automation component (e.g., a line-replaceable unit), as illustrative, non-limiting examples. In the example illustrated, the mobile device 802 includes the camera(s) 110, one or more microphones 806, and a display screen 804.

Components of the processor 190, including the vehicle automation system 140, are integrated in the mobile device 802 and are illustrated using dashed lines to indicate internal components that are not generally visible to a user of the mobile device 802. Optionally, the mobile device 802 can include one or more of the sensor(s) 114, the modem 170, or both.

Inclusion of the vehicle automation system 140 in the mobile device 802 enables the mobile device 802 to perform one or more operations associated with the vehicle automation system 140. For example, the vehicle automation system 140 of the mobile device 802 can be configured to obtain a set of images (e.g., the images 112) representing a scene associated with the vehicle (e.g., the ego vehicle 152) and to generate language-grounded scene tokens (e.g., the language-grounded scene tokens 208) based on the set of images. The vehicle automation system 140 can also be configured to provide the language-grounded scene tokens to a planning transformer (e.g., the planning transformer 144) to generate a path plan prediction (e.g., the path plan prediction 148) for the vehicle.

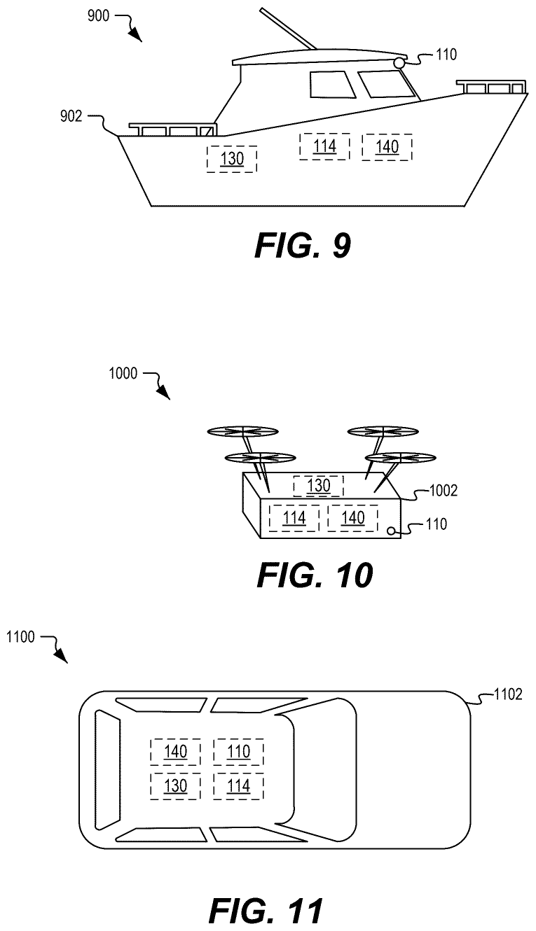

FIG. 9 depicts an implementation 900 in which the device 102 includes or is integrated within a vehicle, which in FIG. 9 includes a watercraft 902. In FIG. 9, the watercraft 902 includes the camera(s) 110. Optionally, the watercraft 902 can also include one or more of the sensor(s) 114.

Components of the processor 190, including the vehicle automation system 140, are integrated in the watercraft 902. For example, the watercraft 902 includes the vehicle automation system 140. In this example, the watercraft 902 can correspond to the ego vehicle 152 of FIG. 1, and the vehicle automation system 140 can be configured as described with reference to any of FIGS. 1-8, to provide vehicle automation functionality to the watercraft 902. For example, the vehicle automation system 140 of the watercraft 902 can be configured to obtain a set of images (e.g., the images 112) representing a scene associated with the watercraft 902 and to generate language-grounded scene tokens (e.g., the language-grounded scene tokens 208) based on the set of images. The vehicle automation system 140 can also be configured to provide the language-grounded scene tokens to a planning transformer (e.g., the planning transformer 144) to generate a path plan prediction (e.g., the path plan prediction 148) for the watercraft 902. Control systems 130 of the watercraft 902 can generate control signals to control various aspects of operations of the watercraft 902 based on the path plan prediction. To illustrate, the control systems 130 can change the heading or speed of the watercraft 902 based on the path plan prediction.

Although the watercraft 902 is illustrated in FIG. 9 as a boat, in other examples, the watercraft can correspond to a submersible, a ship, a barge, a ferry, or another type of watercraft. Further, the watercraft 902 can be crewed or uncrewed.

FIG. 10 depicts an implementation 1000 in which the device 102 includes or is integrated within a vehicle, which in FIG. 10 includes an aircraft 1002. In FIG. 10, the aircraft 1002 includes the camera(s) 110. Optionally, the aircraft 1002 can also include one or more of the sensor(s) 114.

Components of the processor 190, including the vehicle automation system 140, are integrated in the aircraft 1002. For example, the aircraft 1002 includes the vehicle automation system 140. In this example, the aircraft 1002 can correspond to the ego vehicle 152 of FIG. 1, and the vehicle automation system 140 can be configured as described with reference to any of FIGS. 1-8, to provide vehicle automation functionality to the aircraft 1002. For example, the vehicle automation system 140 of the aircraft 1002 can be configured to obtain a set of images (e.g., the images 112) representing a scene associated with the aircraft 1002 and to generate language-grounded scene tokens (e.g., the language-grounded scene tokens 208) based on the set of images. The vehicle automation system 140 can also be configured to provide the language-grounded scene tokens to a planning transformer (e.g., the planning transformer 144) to generate a path plan prediction (e.g., the path plan prediction 148) for the aircraft 1002. Control systems 130 of the aircraft 1002 can generate control signals to control various aspects of operations of the aircraft 1002 based on the path plan prediction. To illustrate, the control systems 130 can change the heading, altitude, attitude, or speed of the aircraft 1002 based on the path plan prediction.

Although the aircraft 1002 is illustrated in FIG. 10 as a drone, in other examples, the aircraft 1002 can correspond to a fixed wing aircraft, a rotary wing aircraft, an aerostat, a hybrid aircraft, or another type of aircraft. Further, the aircraft 1002 can be crewed or uncrewed.

FIG. 11 depicts an implementation 1100 in which the device 102 includes or is integrated within a vehicle, which in FIG. 11 includes a land craft 1102. In FIG. 11, the land craft 1102 includes the camera(s) 110. Optionally, the land craft 1102 can also include one or more of the sensor(s) 114.

Components of the processor 190, including the vehicle automation system 140, are integrated in the land craft 1102. For example, the land craft 1102 includes the vehicle automation system 140. In this example, the land craft 1102 can correspond to the ego vehicle 152 of FIG. 1, and the vehicle automation system 140 can be configured as described with reference to any of FIGS. 1-8, to provide vehicle automation functionality to the land craft 1102. For example, the vehicle automation system 140 of the land craft 1102 can be configured to obtain a set of images (e.g., the images 112) representing a scene associated with the land craft 1102 and to generate language-grounded scene tokens (e.g., the language-grounded scene tokens 208) based on the set of images. The vehicle automation system 140 can also be configured to provide the language-grounded scene tokens to a planning transformer (e.g., the planning transformer 144) to generate a path plan prediction (e.g., the path plan prediction 148) for the land craft 1102. Control systems 130 of the land craft 1102 can generate control signals to control various aspects of operations of the land craft 1102 based on the path plan prediction. To illustrate, the control systems 130 can change the heading or speed of the land craft 1102 based on the path plan prediction.

Although the land craft 1102 is illustrated in FIG. 11 as a car, in other examples, the land craft 1102 can correspond to another type of land craft, such as a truck. Further, the land craft 1102 can be crewed or uncrewed.

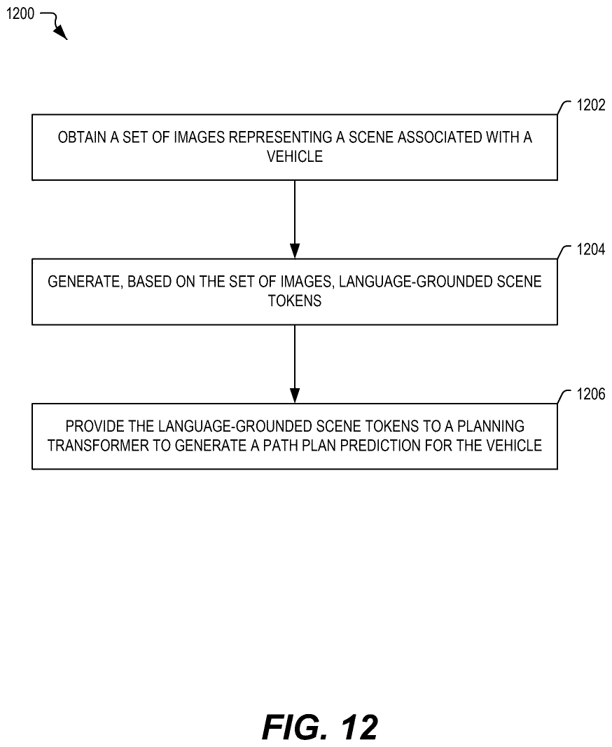

Referring to FIG. 12, a particular implementation of a method 1200 of language-grounded vehicle path planning is shown. In a particular aspect, one or more operations of the method 1200 are performed by at least one of the vehicle automation system 140, the processor 190, the device 102, the system 100 of FIG. 1, or a combination thereof.

The method 1200 includes, at block 1202, obtaining a set of images representing a scene associated with the vehicle. For example, the set of images can correspond to at least a subset of the images 112. The method 1200 also includes, at block 1204, generating, based on the set of images, language-grounded scene tokens. For example, the language-grounded scene model 142 (and optionally the adapters 204) can generate the language-grounded scene tokens 208.

In some embodiments, generating the language-grounded scene tokens includes providing the set of images as input to an image encoder (e.g., at language-grounded bird's eye view encoder) to generate image features. For example, the images 112 can be provided as input to the image encoder 502 of FIG. 5 to generate the image features 504. In such embodiments, generating the language-grounded scene tokens also includes providing the image features as input to a perception machine-learning model (e.g., a language-grounded map transformer model) to generate map data representing objects within the scene. For example, the image features 504 can be provided as input to the perception ML model 506 to generate the map data 510.

In such embodiment, generating the language-grounded scene tokens also includes providing the image features, the map data, or both, as input to a prediction machine-learning model (e.g., a language-grounded motion transformer model) to generate motion prediction data representing trajectory predictions associated with the scene. For example, the image features 504, the map data 510, or both, can be provided as input to the prediction ML model 512 to generate the motion prediction data 516. In such embodiments, generating the language-grounded scene tokens also includes generating scene feature data based on the image features, the map data, the motion prediction data, or a combination thereof. For example, the scene feature data 520 can include the image features 504, the map data 510, the motion prediction data 516, or a combination thereof.

The method 1200 includes, at block 1206, providing the language-grounded scene tokens to a planning transformer to generate a path plan prediction for the vehicle. For example, the language-grounded scene tokens 208 can be provided as input to the planning transformer 144 to generate the path plan prediction 148. In some embodiments, the path plan prediction can be based on both images and sensor data (e.g., the sensor data 116).

The method 1200 can be performed during training or during inference. For example, when the method 1200 is performed during inference, the path plan prediction 148 can be provided to control systems 130 of the vehicle to generate vehicle control signals 216. When the method 1200 is performed during training, the method 1200 can include providing the language-grounded scene tokens and one or more text tokens as input to a large language model to generate language-grounded scene data including a scene description, a masked-scene prediction, a future scene prediction, a waypoint prediction, or a combination thereof. For example, the language-grounded scene tokens 208 and the LLM output 310 can be provided as input to the LLM 146 to generate the LLM output 310, which can include, the scene description 610, the masked-scene description 612, the future scene prediction 614, the waypoint prediction 618, or a combination thereof. During training, the method 1200 can also include determining an error value based on the language-grounded scene data (e.g., based on differences between the LLM output 310 generated based on the language-grounded scene tokens 208 and ground-truth information in the training data 404). Parameters (e.g., the parameters 406) of a scene feature data model (e.g., the language-grounded scene model 142 before language grounding is complete) can be modified based on the error value to improve language grounding of the scene feature data model.

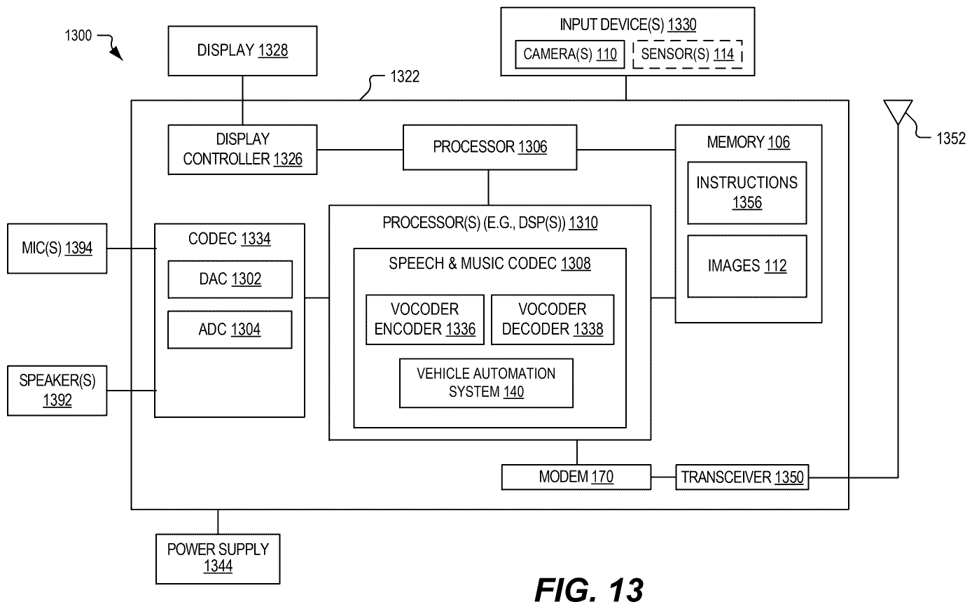

The method 1200 of FIG. 12 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1200 of FIG. 12 may be performed by a processor that executes instructions, such as described with reference to FIG. 13.

Referring to FIG. 13, a block diagram of a particular illustrative implementation of a device is depicted and generally designated 1300. In various implementations, the device 1300 may have more or fewer components than illustrated in FIG. 13. In an illustrative implementation, the device 1300 may correspond to the device 102. In an illustrative implementation, the device 1300 may perform one or more operations described with reference to FIGS. 1-12.

In a particular implementation, the device 1300 includes a processor 1306 (e.g., a CPU). The device 1300 may include one or more additional processors 1310 (e.g., one or more DSPs). In a particular aspect, the processor 190 of FIG. 1 corresponds to the processor 1306, the processors 1310, or a combination thereof. The processors 1310 may include a speech and music coder-decoder (CODEC) 1308 that includes a voice coder (“vocoder”) encoder 1336, a vocoder decoder 1338, the vehicle automation system 140, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations of a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

A processor can be configured to perform a specific task by including, within the processor, specialized hardware to perform the task. Additionally, or alternatively, the processor can be configured to perform a specific task by loading and/or executing instructions (e.g., computer code) that, when executed, cause the processor to perform the specific task. Loading executable instructions to perform the task causes an internal configuration change in the processor that transforms what may otherwise be a general-purpose processor into a special purpose processor for performing the task.

In FIG. 13, the device 1300 includes the memory 106 and a CODEC 1334. The memory 106 may include instructions 1356, that are executable by the one or more additional processors 1310 (or the processor 1306) to implement the functionality described with reference to the vehicle automation system 140. The device 1300 can also include the modem 170 coupled, via a transceiver 1350, to an antenna 1352.

The device 1300 may include a display 1328 coupled to a display controller 1326. One or more speakers 1392, one or more microphones 1394, or both, can be coupled to the CODEC 1334. The CODEC 1334 may include a digital-to-analog converter (DAC) 1302, an analog-to-digital converter (ADC) 1304, or both. In a particular implementation, the CODEC 1334 may receive analog signals from the microphone(s) 1394, convert the analog signals to digital signals using the analog-to-digital converter 1304, and provide the digital signals to the speech and music codec 1308. The speech and music codec 1308 may process the digital signals and provide the processed digital signals to the CODEC 1334. The CODEC 1334 may convert the digital signals to analog signals using the digital-to-analog converter 1302 and may provide the analog signals to the speaker(s) 1392.

In a particular implementation, the device 1300 may be included in a system-in-package or system-on-chip device 1322. In a particular implementation, the memory 106, the processor 1306, the processors 1310, the display controller 1326, the CODEC 1334, and the modem 170 are included in the system-in-package or system-on-chip device 1322. In a particular implementation, one or more input devices 1330 (e.g., the cameras 110, the sensors 114, or another input device), and a power supply 1344 are coupled to the system-in-package or the system-on-chip device 1322. Moreover, in a particular implementation, as illustrated in FIG. 13, the display 1328, the input device(s) 1330, the speaker(s) 1392, the microphone(s) 1394, the antenna 1352, and the power supply 1344 are external to the system-in-package or the system-on-chip device 1322. In a particular implementation, each of the display 1328, the input device(s) 1330, the speaker(s) 1392, the microphone(s) 1394, the antenna 1352, and the power supply 1344 may be coupled to a component of the system-in-package or the system-on-chip device 1322, such as an interface (e.g., one or more of the interface(s) 104 of FIG. 1) or a controller.

The device 1300 may include, correspond to, or be integrated with a mobile communication device, a smart phone, a cellular phone, a laptop computer, a computer, a tablet, a personal digital assistant, a server, a navigation device, a vehicle, a watercraft, an aircraft, a land craft, a voice-activated device, a portable electronic device, a car, a communication device, or any combination thereof.

In conjunction with the described implementations, an apparatus includes means for obtaining a set of images representing a scene associated with the vehicle. For example, the means for obtaining a set of images representing a scene associated with the vehicle can correspond to the device 102, the cameras 110, the interfaces 104, the modem 170, the processors 190, the vehicle automation system 140, the language-grounded scene model 142, the ego vehicle 152, the input 706, the integrated circuit 702, the processor 1306, the processor(s) 1310, the input device(s) 1330, the transceiver 1350, one or more other circuits or components configured to obtain a set of images representing a scene associated with the vehicle, or any combination thereof.

The apparatus also includes means for generating, based on the set of images, language-grounded scene tokens. For example, the means for generating the language-grounded scene tokens can correspond to the device 102, the processors 190, the vehicle automation system 140, the language-grounded scene model 142, the ego vehicle 152, the adapters 204, the image encoder 502, the perception ML model 506, the prediction ML model 512, the integrated circuit 702, the processor 1306, the processor(s) 1310, one or more other circuits or components configured to generate language-grounded scene token based on the set of images, or any combination thereof.

The apparatus also includes means for providing the language-grounded scene tokens to a planning transformer to generate a path plan prediction for the vehicle. For example, the means for providing the language-grounded scene tokens to a planning transformer to generate a path plan prediction for the vehicle can correspond to the device 102, the processors 190, the vehicle automation system 140, the language-grounded scene model 142, the ego vehicle 152, the adapters 204, the integrated circuit 702, the processor 1306, the processor(s) 1310, one or more other circuits or components configured to provide language-grounded scene tokens to a planning transformer to generate a path plan prediction for the vehicle, or any combination thereof.

In some implementations, a non-transitory computer-readable medium (e.g., a computer-readable storage device, such as the memory 106) includes instructions (e.g., the instructions 1356) that, when executed by one or more processors (e.g., one or more of the processors 190, the processor(s) 1310, or the processor 1306), cause the one or more processors to obtain a set of images (e.g., the images 112) representing a scene associated with the vehicle (e.g., the ego vehicle 152), generate, based on the set of images, language-grounded scene tokens (e.g., the language-grounded scene tokens 208), and provide the language-grounded scene tokens to a planning transformer (e.g., the planning transformer 144) to generate a path plan prediction (e.g., the path plan prediction 148) for the vehicle.

Particular aspects of the disclosure are described below in sets of interrelated Examples:

According to Example 1, a device includes a memory configured to store images representing a scene associated with a vehicle. The device also includes one or more processors configured to obtain a set of images representing the scene associated with the vehicle. The one or more processors are configured to generate, based on the set of images, language-grounded scene tokens. The one or more processors are configured to provide the language-grounded scene tokens to a planning transformer to generate a path plan prediction for the vehicle.

Example 2 includes the device of Example 1, where the one or more processors are configured to generate vehicle control signals based on the path plan prediction.

Example 3 includes the device of Example 1 or Example 2, where, to generate the language-grounded scene tokens, the one or more processors are configured to provide the set of images as input to an image encoder to generate image features. The one or more processors are configured to provide the image features as input to a perception machine-learning model to generate map data representing objects within the scene. The one or more processors are configured to provide the image features, the map data, or both, as input to a prediction machine-learning model to generate motion prediction data representing trajectory predictions associated with the scene. The one or more processors are configured to generate scene feature data based on the image features, the map data, the motion prediction data, or a combination thereof.

Example 4 includes the device of Example 3, where the image encoder includes a language-grounded bird's eye view encoder.

Example 5 includes the device of Example 3 or Example 4, where the one or more processors are configured to generate the language-grounded scene tokens based on the scene feature data.

Example 6 includes the device of any of Examples 3 to 5, where the prediction machine-learning model includes a language-grounded motion transformer model.

Example 7 includes the device of any of Examples 3 to 6, where the perception machine-learning model includes a language-grounded map transformer model.

Example 8 includes the device of any of Examples 1 to 7, where the one or more processors are configured to provide the language-grounded scene tokens and one or more text tokens as input to a large language model to generate output including a scene description, a masked-scene prediction, a future scene prediction, a waypoint prediction, or a combination thereof.

Example 9 includes the device of Example 8, where the one or more processors are configured to determine an error value based on the output of the large language model and to modify parameters of a scene feature data model based on the error value to improve language grounding of the scene feature data model, where the scene feature data model is configured to generate language-grounded scene feature data used to generate the language-grounded scene tokens.

Example 10 includes the device of any of Examples 1 to 9 and further includes a modem coupled to the one or more processors and configured to receive the images, to send the path plan prediction, or both.

Example 11 includes the device of any of Examples 1 to 10 and further includes one or more cameras coupled to the one or more processors and configured to capture the images.

Example 12 includes the device of any of Examples 1 to 11 and further includes one or more sensors configured to capture sensor data associated with the vehicle, where the one or more processors are configured to generate the path plan prediction based at least in part on the sensor data.

Example 13 includes the device of Example 12, wherein the one or more sensors include a detection and ranging sensor.

Example 14 includes the device of any of Examples 1 to 13, where the memory and the one or more processors are integrated within the vehicle.

Example 15 includes the device of any of Examples 1 to 14, where the vehicle includes an automobile.

Example 16 includes the device of any of Examples 1 to 14, where the vehicle includes an aircraft.

Example 17 includes the device of any of Examples 1 to 14, where the vehicle includes a watercraft.

According to Example 18, a method includes obtaining a set of images representing a scene associated with the vehicle; generating, based on the set of images, language-grounded scene tokens; and providing the language-grounded scene tokens to a planning transformer to generate a path plan prediction for the vehicle.

Example 19 includes the method of Example 18 and further includes generating vehicle control signals based on the path plan prediction.

Example 20 includes the method of Example 18 or Example 19, where generating the language-grounded scene tokens includes providing the set of images as input to an image encoder to generate image features. The method also includes providing the image features as input to a perception machine-learning model to generate map data representing objects within the scene. The method also includes providing the image features, the map data, or both, as input to a prediction machine-learning model to generate motion prediction data representing trajectory predictions associated with the scene. The method also includes generating scene feature data based on the image features, the map data, the motion prediction data, or a combination thereof.

Example 21 includes the method of Example 20, where the image encoder includes a language-grounded bird's eye view encoder.

Example 22 includes the method of Example 20 or Example 21 and further includes generating the language-grounded scene tokens based on the scene feature data.

Example 23 includes the method of any of Examples 20 to 22, where the prediction machine-learning model includes a language-grounded motion transformer model.

Example 24 includes the method of any of Examples 20 to 23, where the perception machine-learning model includes a language-grounded map transformer model.

Example 25 includes the method of any of Examples 18 to 24 and further includes providing the language-grounded scene tokens and one or more text tokens as input to a large language model to generate output including a scene description, a masked-scene prediction, a future scene prediction, a waypoint prediction, or a combination thereof.

Example 26 includes the method of Example 25 and further includes determining an error value based on the output of the large language model and modifying parameters of a scene feature data model based on the error value to improve language grounding of the scene feature data model, where the scene feature data model is configured to generate language-grounded scene feature data used to generate the language-grounded scene tokens.

Example 27 includes the method of any of Examples 18 to 26 and further includes capturing sensor data associated with the vehicle and generating the path plan prediction based at least in part on the sensor data.

According to Example 28, a non-transitory computer-readable medium stores instructions executable to cause one or more processors to obtain a set of images representing a scene associated with the vehicle; generate, based on the set of images, language-grounded scene tokens; and provide the language-grounded scene tokens to a planning transformer to generate a path plan prediction for the vehicle.

Example 29 includes the non-transitory computer-readable medium of Example 28, where the instructions are executable to cause the one or more processors to generate vehicle control signals based on the path plan prediction.

Example 30 includes the non-transitory computer-readable medium of Example 28 or Example 29, where, to generate the language-grounded scene tokens, the instructions are executable to cause the one or more processors to provide the set of images as input to an image encoder to generate image features. The instructions are executable to cause the one or more processors to provide the image features as input to a perception machine-learning model to generate map data representing objects within the scene. The instructions are executable to cause the one or more processors to provide the image features, the map data, or both, as input to a prediction machine-learning model to generate motion prediction data representing trajectory predictions associated with the scene. The instructions are executable to cause the one or more processors to generate scene feature data based on the image features, the map data, the motion prediction data, or a combination thereof.

Example 31 includes the non-transitory computer-readable medium of Example 30, where the image encoder includes a language-grounded bird's eye view encoder.

Example 32 includes the non-transitory computer-readable medium of Example 30 or Example 31, where the instructions are executable to cause the one or more processors to generate the language-grounded scene tokens based on the scene feature data.

Example 33 includes the non-transitory computer-readable medium of any of Examples 30 to 32, where the prediction machine-learning model includes a language-grounded motion transformer model.

Example 34 includes the non-transitory computer-readable medium of any of Examples 30 to 33, where the perception machine-learning model includes a language-grounded map transformer model.

Example 35 includes the non-transitory computer-readable medium of any of Examples 28 to 34, where the instructions are executable to cause the one or more processors to provide the language-grounded scene tokens and one or more text tokens as input to a large language model to generate output including a scene description, a masked-scene prediction, a future scene prediction, a waypoint prediction, or a combination thereof.

Example 36 includes the non-transitory computer-readable medium of Example 35, where the instructions are executable to cause the one or more processors to determine an error value based on the output of the large language model and to modify parameters of a scene feature data model based on the error value to improve language grounding of the scene feature data model, where the scene feature data model is configured to generate language-grounded scene feature data used to generate the language-grounded scene tokens.

According to Example 37, an apparatus includes means for obtaining a set of images representing a scene associated with the vehicle; means for generating, based on the set of images, language-grounded scene tokens; and means for providing the language-grounded scene tokens to a planning transformer to generate a path plan prediction for the vehicle.

Example 38 includes the apparatus of Example 37 and further includes means for generating vehicle control signals based on the path plan prediction.

Example 39 includes the apparatus of Example 37 or Example 38, where the means for generating the language-grounded scene tokens includes means for providing the set of images as input to an image encoder to generate image features. The apparatus includes means for providing the image features as input to a perception machine-learning model to generate map data representing objects within the scene. The apparatus includes means for providing the image features, the map data, or both, as input to a prediction machine-learning model to generate motion prediction data representing trajectory predictions associated with the scene. The apparatus includes means for generating scene feature data based on the image features, the map data, the motion prediction data, or a combination thereof.

Example 40 includes the apparatus of Example 39, where the image encoder includes a language-grounded bird's eye view encoder.

Example 41 includes the apparatus of Examples 39 or Example 40 and further includes means for generating the language-grounded scene tokens based on the scene feature data.

Example 42 includes the apparatus of any of Examples 39 to 41, where the prediction machine-learning model includes a language-grounded motion transformer model.

Example 43 includes the apparatus of any of Examples 39 to 42, where the perception machine-learning model includes a language-grounded map transformer model.

Example 44 includes the apparatus of any of Examples 37 to 43 and further includes means for providing the language-grounded scene tokens and one or more text tokens as input to a large language model to generate output including a scene description, a masked-scene prediction, a future scene prediction, a waypoint prediction, or a combination thereof.

Example 45 includes the apparatus of Example 44 and further includes means for determining an error value based on the output of the large language model and means for modifying parameters of scene feature data model based on the error value to improve language grounding of the scene feature data model, where the scene feature data model is configured to generate language-grounded scene feature data used to generate the language-grounded scene tokens.

Example 46 includes the apparatus of any of Examples 37 to 45 and further includes means for capturing sensor data associated with the vehicle, wherein the means for generating the path plan prediction is configured to generate the path plan prediction based at least in part on the sensor data.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store images that represent scenes associated with a vehicle; and
one or more processors configured to:
obtain a set of images representing a scene associated with the vehicle;
generate, based on the set of images, language-grounded scene tokens; and
provide the language-grounded scene tokens to a planning transformer to generate a path plan prediction for the vehicle.

2. The device of claim 1, wherein the one or more processors are configured to generate vehicle control signals based on the path plan prediction.

3. The device of claim 1, wherein, to generate the language-grounded scene tokens, the one or more processors are configured to:
provide the set of images as input to an image encoder to generate image features;
provide the image features as input to a perception machine-learning model to generate map data representing objects within the scene;
provide the image features, the map data, or both, as input to a prediction machine-learning model to generate motion prediction data representing trajectory predictions associated with the scene; and
generate scene feature data based on the image features, the map data, the motion prediction data, or a combination thereof.

4. The device of claim 3, wherein the image encoder includes a language-grounded bird's eye view encoder.

5. The device of claim 3, wherein the one or more processors are configured to generate the language-grounded scene tokens based on the scene feature data.

6. The device of claim 3, wherein the prediction machine-learning model comprises a language-grounded motion transformer model.

7. The device of claim 3, wherein the perception machine-learning model comprises a language-grounded map transformer model.

8. The device of claim 1, further comprising a modem coupled to the one or more processors and configured to receive the images, to send the path plan prediction, or both.

9. The device of claim 1, further comprising one or more cameras coupled to the one or more processors and configured to capture the images.

10. The device of claim 1, further comprising one or more sensors configured to capture sensor data associated with the vehicle, wherein the one or more processors are configured to generate the path plan prediction based at least in part on the sensor data.

11. The device of claim 1, wherein the device is an automobile.

12. The device of claim 1, wherein the device is an aircraft.

13. The device of claim 1, wherein the device is a watercraft.

14. A method comprising:
obtaining a set of images representing a scene associated with a vehicle;
generating, based on the set of images, language-grounded scene tokens; and
providing the language-grounded scene tokens to a planning transformer to generate a path plan prediction for the vehicle.

15. The method of claim 14, further comprising generating vehicle control signals based on the path plan prediction.

16. The method of claim 14, wherein generating the language-grounded scene tokens comprises:
providing the set of images as input to an image encoder to generate image features;
providing the image features as input to a perception machine-learning model to generate map data representing objects within the scene;
providing the image features, the map data, or both, as input to a prediction machine-learning model to generate motion prediction data representing trajectory predictions associated with the scene; and
generating scene feature data based on the image features, the map data, the motion prediction data, or a combination thereof.

17. The method of claim 14, further comprising:
providing the language-grounded scene tokens and one or more text tokens as input to a large language model to generate language-grounded scene data including a scene description, a masked-scene prediction, a future scene prediction, a waypoint prediction, or a combination thereof.

18. The method of claim 17, further comprising:
determining an error value based on the language-grounded scene data; and
modifying parameters of a scene feature data model based on the error value to improve language grounding of the scene feature data model, wherein the scene feature data model is configured to generate language-grounded scene feature data used to generate the language-grounded scene tokens.

19. The method of claim 14, further comprising one or more sensors configured to capture sensor data associated with the vehicle, wherein the path plan prediction is based at least in part on the sensor data.

20. A non-transitory computer-readable medium storing instructions executable to cause one or more processors to:
obtain a set of images representing a scene associated with a vehicle;
generate, based on the set of images, language-grounded scene tokens; and
provide the language-grounded scene tokens to a planning transformer to generate a path plan prediction for the vehicle.
